(19) United States
(12) Patent Application Publication
(10) Pub. No.: US 2022/0286728 A1
(43) Pub. Date: Sep. 8, 2022

(54) INFORMATION PROCESSING APPARATUS AND INFORMATION PROCESSING METHOD, DISPLAY EQUIPPED WITH ARTIFICIAL INTELLIGENCE FUNCTION, AND RENDITION SYSTEM EQUIPPED WITH ARTIFICIAL INTELLIGENCE FUNCTION

(71) Applicant: SONY GROUP CORPORATION, TOKYO (JP)

(72) Inventors: TATSUSHI NASHIDA, TOKYO (JP); YOSHIYUKI KOBAYASHI, TOKYO (JP)

(21) Appl. No.: 17/637,047

(22) PCT Filed: May 18, 2020
(86) PCT No.: PCT/JP2020/019662

§ 371 Date: Feb. 21, 2022

(30) Foreign Application Priority Data
Aug. 28, 2019 (JP) 2019-155351

(51) Int. Cl. H04N 21/43; H04N 21/422; H04N 21/466

(52) U.S. Cl. CPC H04N 21/4307; H04N 21/42201; H04N 21/4666

(57) ABSTRACT

Provided is an information processing apparatus that gives a rendition effect using an artificial intelligence function while a user is viewing and listening to content. The information processing apparatus that controls an operation of an external device of a display with use of an artificial intelligence function includes an acquisition unit that acquires a video image or an audio output from the display, an estimation unit that estimates the operation of the external device synchronized with the video image or the audio with use of the artificial intelligence function, and an output unit that outputs an instruction of the estimated operation to the external device. The external device is a rendition device that outputs a rendition effect on the basis of the estimated operation.

### TECHNICAL FIELD

A technology disclosed in the present specification (hereinafter referred to as “the present disclosure”) relates to an information processing apparatus and an information processing method each using an artificial intelligence function, a display equipped with artificial intelligence function, and a rendition system equipped with artificial intelligence function.

### BACKGROUND ART

Television has long been widespread for a long period of time. In recent years, with enlargement of a television screen size, quality improvement including video image quality improvement such as a super-resolution technology and conversion into a high dynamic range (e.g., see PTL 1), and sound quality improvement such as band spreading (high resolution) (e.g., see PTL 2) has been also promoted.

On the other hand, a bodily sensation type rendition technology also called “4D” has been gradually widespread in a movie theater or the like. This technology raises a realistic sensation by stimulating senses of audience with use of shifting actions of a seat in frontward and rearward, upward and downward, and leftward and rightward directions, wind (cool wind, hot wind), light (on/off of lighting), water (mist, splash), scents, smoke, body motion, or the like each linked with scenes in a movie currently displayed.

### CITATION LIST

### Patent Literature

[PTL 1]

JP 2019-23798A
[PTL 2]

JP 2017-203999A
[PTL 3]

JP 2015-92529A
[PTL 4]

Japanese Patent No. 4915143
[PTL 5]

JP 2007-143010A
[PTL 6]

JP 2000-156075A

### Technical Problem

An object of the technology according to the present disclosure is to provide an information processing apparatus and an information processing method, a display equipped with artificial intelligence function, and a rendition system equipped with artificial intelligence function which each give a rendition effect by using an artificial intelligence function while a user is viewing and listening to content.

### Solution to Problem

A first aspect of the technology according to the present disclosure is directed to an information processing apparatus that controls an operation of an external device of a display with use of an artificial intelligence function. The information processing apparatus includes an acquisition unit that acquires a video image or an audio output from the display, an estimation unit that estimates the operation of the external device synchronized with the video image or the audio with use of the artificial intelligence function, and an output unit that outputs an instruction of the estimated operation to the external device.

The estimation unit estimates the operation of the external device synchronized with the video image or the audio with use of a neural network having learned a correlation between the video image or the audio output from the display and the operation of the external device.

The external device includes a rendition device that achieves a bodily sensation type rendition effect stimulating senses of a user by outputting a rendition effect on the basis of the estimated operation, and includes a rendition device utilizing wind. In addition, the rendition device further includes a rendition device that utilizes at least one of temperature, water, light, a scent, smoke, and body motion.

Moreover, a second aspect of the technology according to the present disclosure is directed to an information processing method that controls an operation of an external device of a display with use of an artificial intelligence function. The information processing method includes an acquisition step that acquires a video image or an audio output from the display, an estimation step that estimates the operation of the external device synchronized with the video image or the audio with use of the artificial intelligence function, and an output step that outputs an instruction of the estimated operation to the external device.

Further, a third aspect of the technology according to the present disclosure is directed to a display equipped with artificial intelligence function. The display includes a display unit, an estimation unit that estimates, with use of an artificial intelligence function, an operation of an external device synchronized with a video image or an audio output from the display unit, and an output unit that outputs an instruction of the estimated operation to the external device.

In addition, a fourth aspect of the technology according to the present disclosure is directed to a rendition system equipped with artificial intelligence function. The rendition system includes a display unit, an external device, and an estimation unit that estimates an operation of the external device synchronized with a video image or an audio with use of an artificial intelligence function.

Note that the “system” herein refers to a system constituted by a logical set of a plurality of devices (or function modules each achieving a particular function) without particular distinction of whether or not the respective devices or the respective function modules are accommodated in a single housing.

### Advantageous Effects of Invention

Providable according to the technology of the present disclosure are an information processing apparatus and an information processing method, a display equipped with artificial intelligence function, and a rendition system equipped with artificial intelligence function which each give a rendition effect which stimulates senses of a user by using an artificial intelligence function utilizing an item other than a video image or sound of content while the user is viewing and listening to the content.

Note that advantageous effects described in the present specification are presented only by way of example. Advantageous effects produced by the technology according to the present disclosure are not limited to these advantageous effects. Moreover, the technology according to the present disclosure may offer additional advantageous effects other than the above advantageous effects.

Other objects, characteristics, and advantages of the technology according to the present disclosure will become apparent in the light of more detailed description based on an embodiment described below and accompanying drawings.

### BRIEF DESCRIPTION OF DRAWINGS

FIG. 1 is a diagram depicting a configuration example of a system used for viewing and listening to video image content.

FIG. 2 is a diagram depicting a configuration example of a television receiving device 100.

FIG. 3 is a diagram depicting an application example of a panel speaker technology.

FIG. 4 is a diagram depicting a configuration example of a sensor group 400 included in the television receiving device 100.

FIG. 5 is a diagram depicting an example where rendition devices are installed in the same room as a room where the television receiving device 100 is installed.

FIG. 6 is a diagram schematically depicting a control system of the television receiving device 100 for controlling the rendition devices.

FIG. 7 is a diagram depicting a configuration example of a rendition system equipped with artificial intelligence function 700.

FIG. 8 is a diagram depicting a configuration example of a bodily sensation type rendition effect estimation neural network 800.

FIG. 9 is a diagram depicting a configuration example of an artificial intelligence system 900 using a cloud.

### DESCRIPTION OF EMBODIMENT

An embodiment of the technology according to the present disclosure will be hereinafter described in detail with reference to the drawings.

### A. System Configuration

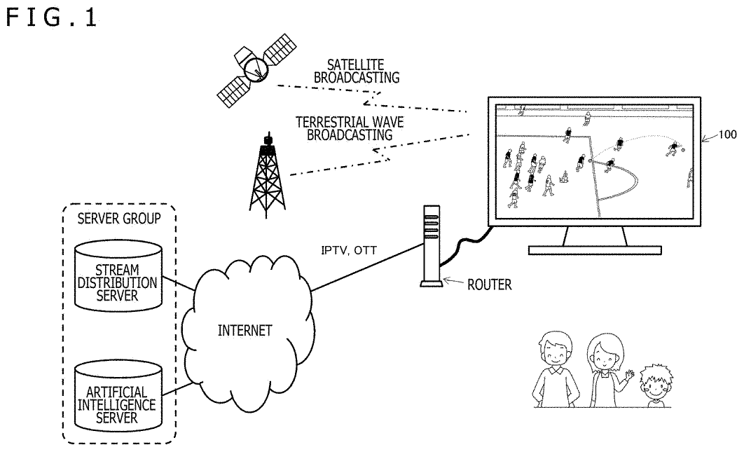

FIG. 1 schematically depicts a configuration example of a system used for viewing and listening to video image content.

For example, a television receiving device 100 is provided in a living room where family members sit in a circle and enjoy conversation, a personal room of a user, or the like. The television receiving device 100 includes a speaker which is disposed alongside of a large screen displaying the video image content and which outputs audios. For example, the television receiving device 100 includes a built-in tuner which tunes in to and receives a broadcasting signal, or a set top box having a tuner function and being externally connected thereto, and is capable of using broadcasting services provided by a television station. The broadcasting signal may be either a terrestrial wave signal or a satellite wave signal.

Moreover, the television receiving device 100 is allowed to use a broadcasting-type video distribution service which distributes videos with use of a network such as IPTV and OTT (Over The Top). Accordingly, the television receiving device 100 is equipped with a network interface card and is interconnected to an external network, such as the Internet, via a router or an access point with use of communication conforming to existing communication standards, such as Ethernet (registered trademark) and Wi-Fi (registered trademark). In terms of functional aspects, the television receiving device 100 also functions as a content acquisition device, a content reproduction device, or a display device which each include a display and has a function of acquiring or reproducing various types of content, i.e., acquiring various types of reproduction content such as video images and audios via broadcasting waves or by streaming or downloading using the Internet, and presenting the content to a user.

A stream distribution server which distributes video image streams is installed on the Internet, and provides broadcasting-type video distribution services for the television receiving device 100.

Moreover, there are installed countless servers each providing various types of services on the Internet. Examples of these servers include a stream distribution server which provides a broadcasting-type video stream distribution service using a network such as IPTV and OTT. The stream distribution service is available on the television receiving device 100 side by starting a browser function and issuing an HTTP (Hyper Text Transfer Protocol) request, for example, to the stream distribution server.

Further, it is assumed in the present embodiment that there also exists an artificial intelligence server which provides an artificial intelligence function on the Internet (or on a cloud) for a client. For example, the artificial intelligence function herein refers to a function of artificially achieving, with use of software or hardware, functions generally exerted by a human brain, such as learning, inference, data collection, and planning. In addition, for example, the artificial intelligence server includes a neural network which performs deep learning (DL) using a model imitating a human cranial nerve circuit. The neural network has a mechanism in which artificial neurons (nodes) constituting a network by synaptic connections each acquire a problem-solution ability while changing connection intensity of the synapses on the basis of learning. The neural network is capable of automatically inferring a problem-solution rule by repeating learning. Note that the “artificial intelligence server” in the present specification is not limited to a single server device, but may be a server in a form of a cloud providing a cloud computing service, for example.

### B. Configuration of Television Receiving Device

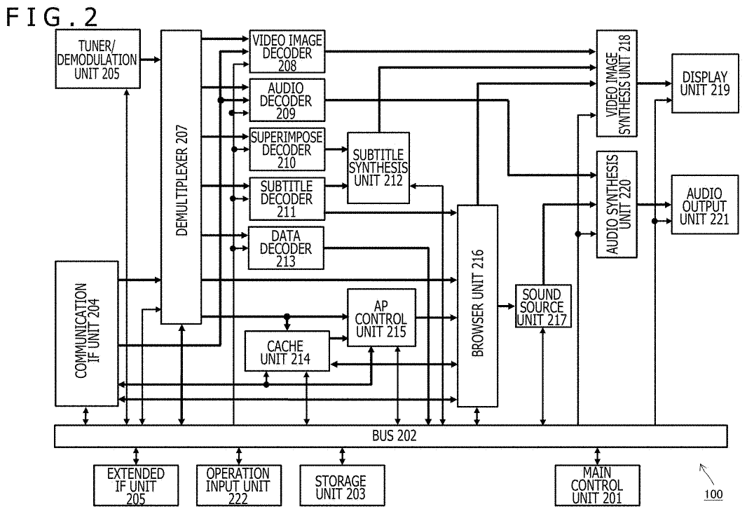

FIG. 2 depicts a configuration example of the television receiving device 100. The television receiving device 100 includes a main control unit 201, a bus 202, a storage unit 203, a communication interface (IF) unit 204, an extended interface (IF) unit 205, a tuner/demodulation unit 206, a demultiplexer (DEMUX) 207, a video image decoder 208, an audio decoder 209, a superimpose decoder 210, a subtitle decoder 211, a subtitle synthesis unit 212, a data decoder 213, a cache unit 214, an application (AP) control unit 215, a browser unit 216, a sound source unit 217, a video image synthesis unit 218, a display unit 219, an audio synthesis unit 220, an audio output unit 221, and an operation input unit 222. Note that the tuner/demodulation unit 206 may be of an externally attached type. For example, an external device equipped with a tuner and a demodulation function, such as a set top box, may be connected to the television receiving device 100.

For example, the main control unit 201 is constituted by a controller, a ROM (Read Only Memory) (note that the ROM is assumed to include a rewritable ROM such as EEPROM (Electrically Erasable Programmable ROM), and a RAM (Random Access Memory), and integratively controls an overall operation of the television receiving device 100 under a predetermined operation program. The controller is constituted by a CPU (Central Processing Unit), an MPU (Micro Processing Unit), a GPU (Graphics Processing Unit), a GPGPU (General Purpose Graphic Processing Unit), or the like. The ROM is a non-volatile memory which stores a basic operation program, such as an operating system (OS), and other operation programs. The ROM may store operation setting values necessary for the operation of the television receiving device 100. The RAM is a work area used during execution of the OS or other operation programs. The bus 202 is a data communication path for achieving data transmission and reception between the main control unit 201 and respective units within the television receiving device 100.

The storage unit 203 is constituted by a non-volatile storage device such as a flash ROM, an SSD (Solid State Drive), or an HDD (Hard Disc Drive). The storage unit 203 stores the operation programs and operation setting values of the television receiving device 100, personal information associated with a user using the television receiving device 100, and the like. Moreover, the storage unit 203 stores an operation program downloaded via the Internet, various types of data generated under this operation program, and the like. Further, the storage unit 203 is capable of storing content such as a video, a still image, and an audio acquired by streaming or downloading via broadcasting waves or the Internet.

The communication interface unit 204 is connected to the Internet via the router (described above) or the like, and achieves data transmission and reception to and from respective server devices or other communication apparatuses on the Internet. In addition, the communication interface unit 204 is assumed to acquire data streams of programs transferred via communication lines. The router may be either of a wired connection type such as Ethernet (registered trademark), or of a wireless connection type such as Wi-Fi (registered trademark). The main control unit 201 is capable of searching for data on a cloud via the communication interface unit 204 on the basis of resource identification information such as URL (Uniform Resource Locator) and URI (Uniform Resiurce Identifier). Accordingly, the communication interface unit 204 also functions as a data searching unit.

The tuner/demodulation unit 206 receives broadcasting waves such as terrestrial broadcasting waves and satellite broadcasting waves via an antenna (not depicted), and tunes in to (selects) a channel of a service (e.g., broadcasting station) desired by the user under control by the main control unit 201. Moreover, the tuner/demodulation unit 206 demodulates a received broadcasting signal to acquire a broadcasting data stream. Note that the television receiving device 100 may have a configuration including a plurality of tuner/demodulation units (i.e., multiple tuner) for a purpose of simultaneous display of a plurality of screens, counterprogram recording, or the like.

The demultiplexer 207 distributes a video image stream, an audio stream, a superimpose data stream, and a subtitle data stream, each corresponding to a real-time presentation element, to the video image decoder 208, the audio decoder 209, the superimpose decoder 210, and the subtitle decoder 211, respectively, on the basis of a control signal included in an input broadcasting data stream. Data input to the demultiplexer 207 includes data provided by a broadcasting service or data provided by a distribution service such as IPTV and OTT. The former is input to the demultiplexer 207 after tuning and demodulation by the tuner/demodulation unit 206, while the latter is input to the demultiplexer 207 after reception by the communication interface unit 204. Moreover, the demultiplexer 207 reproduces a multimedia application and file data corresponding to a constituent element of this application, and outputs the reproduced application and data to the application control unit 215 or temporarily accumulates the application and data in the cache unit 214.

The video image decoder 208 decodes the video image stream input from the demultiplexer 207 and outputs video image information. Moreover, the audio decoder 209 decodes the audio stream input from the demultiplexer 207 and outputs audio data. In digital broadcasting, a video image stream and an audio stream each coded under MPEG2 System Standard, for example, are multiplexed, and are transferred or distributed. The video image decoder 208 and the audio decoder 209 each perform a decoding process, according to a standardized decoding system for each of the coded video image stream and the coded audio stream each demultiplexed by the demultiplexer 207. Note that the television receiving device 100 may include a plurality of the video image decoders 208 and a plurality of the audio decoders 209 to perform the decoding process simultaneously for a plurality of types of video image streams and audio streams.

The superimpose decoder 210 decodes the superimpose data stream input from the demultiplexer 207 and outputs superimpose information. The subtitle decoder 211 decodes the subtitle data stream input from the demultiplexer 207 and outputs subtitle information. The subtitle synthesis unit 212 performs a synthesis process for synthesizing the superimpose information output from the superimpose decoder 210 and the subtitle information output from the subtitle decoder 211.

The data decoder 213 decodes a data stream multiplexed onto a MPEG-2 TS stream together with video images or audios. For example, the data decoder 213 notifies the main control unit 201 of a result of decoding of a general-purpose event message stored in a descriptor region of a PMT (Program Map Table) which is a type of a PSI (Program Specific Information) table.

The application control unit 215 receives an input of control information included in a broadcasting data stream from the demultiplexer 207, or acquires the control information from a server device on the Internet via the communication interface unit 204, and interprets the control information received from either of these.

The browser unit 216 presents a multimedia application file acquired from a server device on the Internet via the cache unit 214 or the communication interface unit 204, or presents file data as a constituent element of the multimedia application file, according to an instruction from the application control unit 215. Examples of the multimedia application file herein include an HTML (Hyper Text Markup Language) document and a BML (Broadcast Markup Language) document. Moreover, it is assumed that the browser unit 216 also executes reproduction of audio data of the application by regulating the sound source unit 217.

The video image synthesis unit 218 receives inputs of the video image information output from the video image decoder 208, the subtitle information output from the subtitle synthesis unit 212, and the application information output from the browser unit 216, and performs a process for appropriately selecting any of a plurality of these items of input information or superimposing these items of input information. The video image synthesis unit 218 includes a video RAM (not depicted). The display unit 219 is driven to display on the basis of video image information input to this video RAM. Moreover, the video image synthesis unit 218 also performs, as necessary under control by the main control unit 201, a superimposing process for superimposing pieces of screen information, the screen information being associated with an EPG (Electronic Program Guide) screen, graphics such as OSD (On Screen Display) generated by an application executed by the main control unit 201, and the like.

Note that the video image synthesis unit 218 may perform, before or after the superimposing process for the plurality of pieces of screen information, a super-resolution process for converting an image into a super-resolution image, or an image quality improving process such as conversion into a high dynamic range which improves a luminance dynamic range of an image.

The display unit 219 presents, to the user, a screen displaying the video image information selected or subjected to the superimposing process by the video image synthesis unit 218. For example, the display unit 219 is a display device constituted by a liquid crystal display, an organic EL (Electro-Luminescence) display, a self-emitting display using minute LED (Light Emitting Diode) elements as pixels (e.g., see PTL 3), or the like, for example. Moreover, the display unit 219 may be constituted by a display device to which a partial driving technology is applied to control brightness for each of plural regions produced by dividing a screen. A display using a transmission-type liquid crystal panel offers an advantage that luminance contrast improves by emitting bright backlight to a region of a high signal level and emitting dark backlight to a region of a low signal level. A partial driving type display device can achieve a high dynamic range by raising luminance of white display partially executed by using a push-up technology which intensively emits light by allocating power reduced at a dark portion to a region of a high signal level (while fixing output power of the entire backlight) (e.g., see PTL 4).

The audio synthesis unit 220 receives inputs of audio information output from the audio decoder 209 and audio data of an application reproduced by the sound source unit 217, and performs a process for selection, synthesis, or the like as necessary. Note that the audio synthesis unit 220 may perform a sound quality improving process such as band spreading (high resolution) for input audio data or audio data to be output.

The audio output unit 221 is used for audio output of program content or data broadcasting content to which the tuner/demodulation unit 206 has been tuned in, or for output of audio data (of voice guidance or synthesized voices of a voice agent, for example) processed by the audio synthesis unit 220. The audio output unit 221 is constituted by an acoustic generation element such as a speaker. For example, the audio output unit 221 may be a speaker array (multichannel speaker or ultra-multichannel speaker) constituted by a combination of a plurality of speakers. Some or all of the speakers of the audio output unit 221 may be externally connected to the television receiving device 100. In a case where the audio output unit 221 includes a plurality of speakers, audio video image localization is achievable by reproducing audio signals with use of a plurality of output channels. Moreover, a sound field is controllable with higher resolution by increasing the number of channels and multiplexing the speakers.

The external speaker may be either of a type installed in front of the television set, such as a sound bar, or of a type wirelessly connected to the television set, such as a wireless speaker. Alternatively, the external speaker may be a speaker connected to another audio product via an amplifier or the like. Alternatively, the external speaker may be a smart speaker which is equipped with a speaker and which is capable of receiving an audio input, a wireless headphone/headset, a tablet, a smartphone, a PC (Personal Computer), what is generally called a smart home appliance such as a refrigerator, a washing machine, an air conditioner, a vacuum cleaner, or lighting equipment, or an IoT (Internet of Things) home appliance.

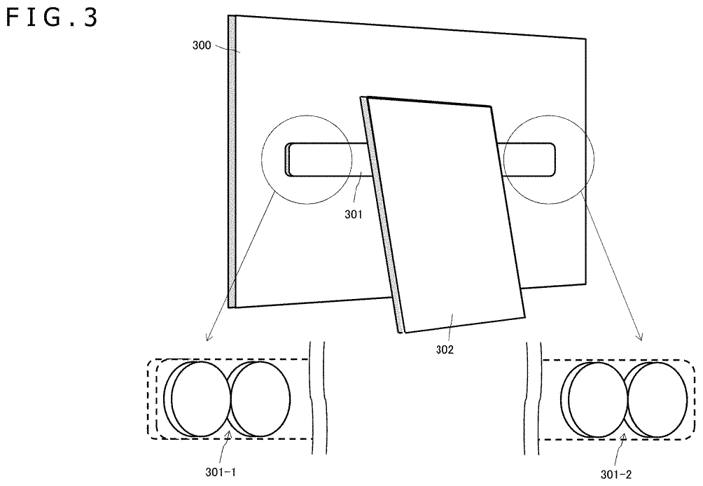

The audio output unit 221 can be constituted by a cone type speaker or a flat panel type speaker (e.g., see PTL 5). Needless to say, the audio output unit 221 can be a speaker array constituted by a combination of different types of speakers. Moreover, the speaker array may include a speaker which achieves an audio output by oscillating the display unit 219 using one or more exciters (actuators) for generating oscillation. The exciter (actuator) may be of a type attached to the display unit 219 afterwards. FIG. 3 depicts an application example of a panel speaker technology to a display. A display 300 is supported by a stand 302 disposed at the rear. A speaker unit 301 is attached to a rear surface of the display 300. An exciter 301-1 disposed at a left end of the speaker unit 301 and an exciter 301-2 disposed at a right end of the speaker 301-2 each constitute a speaker array. The respective exciters 301-1 and 301-2 are capable of oscillating the display 300 and outputting an acoustic sound on the basis of left and right audio signals, respectively. The stand 302 may include a built-in sub-woofer which outputs an acoustic sound in a low sound range. Note that the display 300 corresponds to the display unit 219 using an organic EL element.

Returning again to FIG. 2, a configuration of the television receiving device 100 will be described. The operation input unit 222 is an instruction input unit through which the user inputs an operation instruction given to the television receiving device 100. For example, the operation input unit 222 is constituted by operation keys including an arrangement of a remote control reception unit which receives a command transmitted from a remote controller (not depicted), and button switches. Moreover, the operation input unit 222 may include a touch panel overlapped on a screen of the display unit 219. Further, the operation input unit 222 may include an external input device connected to the extended interface unit 205, such as a keyboard.

The extended interface unit 205 is a group of interfaces for extending the function of the television receiving device 100 and is constituted by an analog video image, an audio interface, a USB (Universal Serial Bus) interface, a memory interface, or the like, for example. The extended interface unit 205 may include a digital interface constituted by a DVI terminal, an HDMI (registered trademark) terminal, a Display Port (registered trademark) terminal, or the like.

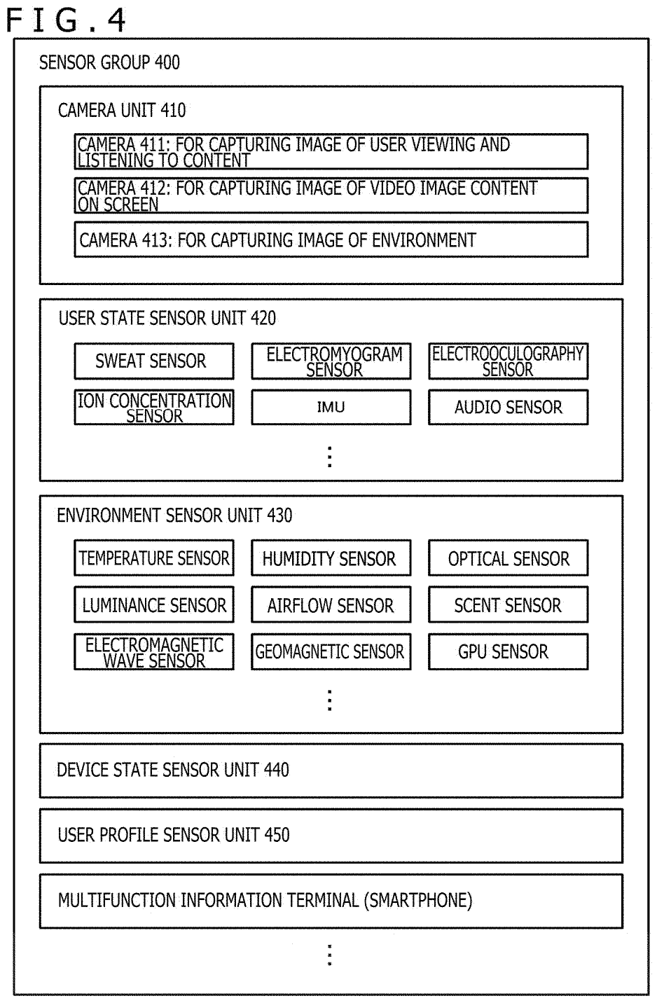

According to the present embodiment, the extended interface 205 is also used as an interface for taking in sensor signals of various types of sensors included in a sensor group (described below, see FIG. 4). It is assumed that the sensors include both a sensor equipped inside the main body of the television receiving device 100 and a sensor externally connected to the television receiving device 100. The sensor externally connected include a sensor built in another CE (Consumer Electronics) apparatus or in an IoT device, the CE apparatus or the IoT device being present in the same space as the space where the television receiving device 100 is present. The extended interface 205 may take in the sensor signals after completion of signal processing such as noise removal and completion of digital conversion, or may take in the sensor signals as unprocessed RAW data (analog waveform signals).

Moreover, according to the present embodiment, the extended interface 205 is also used as an interface for connecting (or transmitting commands) to various types of devices for stimulating senses of the user by utilizing wind (cool wind, hot wind), light (on/off of lighting), water (mist, splash), scents, smoke, body motion, or the like other than video images and sound of content, in synchronization with video images and sound output from the display unit 219 and the audio output unit 221, to raise a realistic sensation. For example, the main control unit 201 estimates a stimulus raising a realistic sensation by using an artificial intelligence function to control driving of the respective devices.

A device which applies a stimulus for improving a realistic sensation to the user viewing and listening to content currently reproduced by the television receiving device 100 will be hereinafter also referred to as a “rendition device.” Examples of the rendition device include an air conditioner, a fan, a heater, lighting equipment (e.g., ceiling area lighting, stand light, and table lamp), a spray, an aroma diffuser, and a smoke generator. Moreover, an autonomous device such as a wearable device, a handy device, an IoT device, an ultrasonic array speaker, or a drone can be used as the rendition device. The wearable device herein includes a device of a bracelet type, a neck strap type, and the like.

The rendition device may be either a device which utilizes a home appliance already installed in a room where the television receiving device 100 is installed, or a dedicated device which applies a stimulus for increasing a realistic sensation to the user. Moreover, the rendition device may be either an external device externally connected to the television receiving device 100, or a built-in device provided within a housing of the television receiving device 100. For example, the rendition device provided as an external device is connected to the television receiving device 100 via the extended interface 205, or via the communication interface 204 with use of a home network. In addition, for example, the rendition device provided as a built-in device is incorporated in the television receiving device 100 with the bus 202 interposed between the rendition device and the television receiving device 100.

Note that details of the rendition device and the artificial intelligence function will be described below.

### C. Sensing Function

The television receiving device 100 includes various types of sensors to detect a video image or an audio currently reproduced or to detect an environment where the television receiving device 100 is installed as well as a state and a profile of the user.

Note that the simple expression of the “user” in the present specification is assumed to refer to a person viewing and listening to video image content displayed on the display unit 219 (including a person scheduled to view and listen to the video image content) unless otherwise stated.

FIG. 4 depicts a configuration example of a sensor group 400 included in the television receiving device 100. The sensor group 400 is constituted by a camera unit 410, a user state sensor unit 420, an environment sensor unit 430, a device state sensor unit 440, and a user profile sensor unit 450.

The camera unit 410 includes a camera 411 which captures an image of the user viewing and listening to the video image content displayed on the display unit 219, a camera 412 which captures an image of the video image content displayed on the display unit 219, and a camera 413 which captures an image of a room interior (or installation environment) in which the television receiving device 100 is installed.

For example, the camera 411 is installed in the vicinity of the center of the upper edge of the screen of the display unit 219, and captures an image of the user viewing and listening to the video image content in a preferable manner. For example, the camera 412 is installed in such a position as to face the screen of the display unit 219, and captures an image of the video image content currently viewed and listened to by the user. Alternatively, the user may wear goggles equipped with the camera 412. It is also assumed that the camera 412 has a function of recording audios of the video image content (recording sound) as well. Moreover, the camera 413 is constituted by an omnidirectional camera or a wide angle camera, for example, and captures an image of the room interior (or installation environment) where the television receiving device 100 is installed. Alternatively, for example, the camera 413 may be a camera carried on a camera table (camera platform) rotatable around each of a role axis, a pitch axis, and a yaw axis. However, the camera 410 is unnecessary in a case where sufficient environment data is acquirable by the environment sensor 430, or in a case where environment data itself is unnecessary.

The user state sensor unit 420 is constituted by one or more sensors each acquiring state information associated with a state of the user. For example, it is intended that the user state sensor unit 420 acquires, as the state information, a work state of the user (whether or not the user is viewing and listening to the video image content), a behavior state of the user (a movement state such as standing still, walking, and running, an eyelid opening-closing state, a visual line direction, and sizes of pupils), a mental state (e.g., a degree of impression, a degree of excitement, a degree of wakefulness, a feeling, and an emotion, such as whether or not the user is absorbed in or focused on the video image content), and a physiological state. The user state sensor unit 420 may include various types of sensors such as a sweat sensor, an electromyogram sensor, an electrooculography sensor, an electroencephalograph sensor, a breath sensor, a gas sensor, an ion concentration sensor, and an IMU (Inertial Measurement Unit) measuring a behavior of the user, and may also include an audio sensor collecting utterances of the user (e.g., microphone). Note that the microphone is not necessarily required to be integrated with the television receiving device 100, but may be a microphone mounted on a product installed in front of the main body of the television receiving device 100, such as a sound bar. Alternatively, the microphone may be a device equipped with a microphone externally attached and connected by wire or wirelessly. The device equipped with a microphone externally attached may be a smart speaker which is equipped with a microphone and which is capable of receiving an audio input, a wireless headphone/headset, a tablet, a smartphone, a PC, what is generally called a smart home appliance such as a refrigerator, a washing machine, an air conditioner, a vacuum cleaner, and lighting equipment, or an IoT home appliance.

The environment sensor unit 430 is constituted by various types of sensors each measuring information associated with an environment such as the room interior where the television receiving device 100 is installed. For example, the environment sensor unit 430 includes a temperature sensor, a humidity sensor, an optical sensor, a luminance sensor, an airflow sensor, a scent sensor, an electromagnetic wave sensor, a geomagnetic sensor, a GPS (Global Positioning System) sensor, and an audio sensor for collecting surrounding sound (e.g., microphone).

The device state sensor unit 440 is constituted by one or more sensors each acquiring an interior state of the television receiving device 100. Alternatively, a circuit component such as the video image decoder 208 and the audio decoder 209 may have a function of externally outputting a state of an input signal, a processing state of an input signal, or the like to play a role of a sensor for detecting the internal state of the device. Moreover, the device state sensor unit 440 may detect an operation performed by the user for the television receiving device 100 and other devices, or may store a history of operations previously performed by the user.

The user profile sensor unit 450 detects profile information associated with the user viewing and listening to the video image content displayed on the television receiving device 100. The user profile sensor unit 450 is not necessarily required to be constituted by a sensor element. For example, the user profile sensor unit 450 may detect a user profile such as the age and the gender of the user on the basis of a facial image of the user captured by the camera 411, utterances of the user collected by the audio sensor, or the like. Moreover, the user profile sensor unit 450 may obtain a user profile acquired by a multifunction information terminal carried by the user, such as a smartphone, via linkage between the television receiving device 100 and the smartphone. However, the user profile sensor unit does not need to detect sensitive information associated with privacy or secrets of the user. Further, a profile of an identical user does not need to be detected for every viewing and listening to the video image content by the same user. For example, user profile information once acquired may be stored in the EEPROM (described above) in the main control unit 201.

In addition, a multifunction information terminal carried by the user, such as a smartphone, may be used as the user state sensor unit 420, the environment sensor unit 430, or the user profile sensor unit 450 by linkage between the television receiving device 100 and the smartphone. For example, data managed by an application, such as sensor information acquired by a sensor built in the smartphone, a health care function (e.g., pedometer), a calendar, a schedule book, a memorandum, a mail, and a post history to SNS (Social Network Service) may be added to the user state data or the environment data. Moreover, a sensor built in another CE apparatus or an IoT device which is present in the same space as the space where the television receiving device 100 is present may be used as the user state sensor unit 420 or the environment sensor unit 430. Further, the user state sensor unit 420 or the environment sensor unit 430 may detect a visitor by detecting an interphone sound or communicating with an interphone system.

### D. Rendition Device

The television receiving device 100 according to the present embodiment has a large screen and adopts a quality improving technology including video image quality improvement such as a super-resolution technology and conversion into a high dynamic range as well as sound quality improvement such as band spreading (high resolution).

Moreover, the television receiving device 100 according to the present embodiment is connected to various types of rendition devices. Each of the rendition devices refers to a device which stimulates senses of the user with use of items other than video images and sound of content currently reproduced by the television receiving device 100, to raise a realistic sensation of the user viewing and listening to the content. Accordingly, the television receiving device 100 can achieve bodily sensation type rendition with a rise of a realistic sensation of the user by stimulating the senses of the user with use of items other than video images and sound of content currently viewed and listened to by the user, in synchronization with the video images and the sound of the content.

Each of the rendition devices may be either a device which uses a home appliance already installed in the room where the television receiving device 100 is installed, or a dedicated device which applies a stimulus for increasing a realistic sensation to the user. Moreover, each of the rendition devices may be either an external device externally connected to the television receiving device 100, or a built-in device provided within the housing of the television receiving device 100. The rendition device provided as an external device is connected to the television receiving device 100 via the extended interface 205 or via the communication interface 204 with use of a home network, for example. In addition, for example, the rendition device provided as a built-in device is incorporated in the television receiving device 100 with the bus 202 interposed between the rendition device and the television receiving device 100.

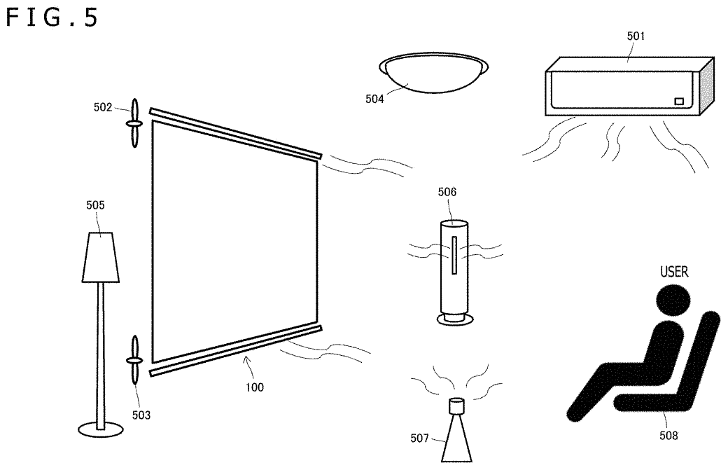

FIG. 5 depicts an installation example of the rendition device. According to the example depicted in the figure, the user is sitting on a chair in such a position as to face the screen of the television receiving device 100.

An air conditioner 501, fans 502 and 503 provided within the television receiving device 100, a fan (not depicted), a heater (not depicted), and the like are disposed as rendition devices utilizing wind in a room where the television receiving device 100 is installed. The fans 502 and 503 in the example depicted in FIG. 5 are disposed within the housing of the television receiving device 100 such that wind is supplied from the upper edge and the lower edge of the large screen of the television receiving device 100 with use of the fans 502 and 503, respectively. A wind speed, a wind volume, a wind pressure, a wind direction, fluctuations, an airflow temperature, and the like of the fans 502 and 503 are controllable.

Clothes worn by the user, hair of the user, a curtain at a window swing by the wind being applied. Rendition utilizing wind has been conventionally adopted in a stage or the like. A realistic sensation which feels as if the user were present in a world of a video image can be raised by applying strong wind, weak wind, cool wind, hot wind, or the like from each of the fans 502 and 503 to the user in synchronization with video images and sound, or changing the wind direction according to scene switching. It is assumed in the present embodiment that outputs from the fans 502 and 503 are controllable in a wide range from a blast as produced by an air cannon in a loud explosion scene to a breeze floating with ripples in a quiet lakeside. Moreover, it is assumed that the flow direction of the wind from each of the fans 502 and 503 is controllable with a limitation to a region finely defined. For example, a bodily sensation which feels as if whispering came to the user in the wind is expressed by supplying a breeze to the ears of the user.

The air conditioner 501, the fans 502 and 503, and the heater (not depicted) herein are each also operable as a rendition device utilizing temperature. The rendition device utilizing temperature may raise an effect of a bodily sensation achieved by wind or water when used together with a rendition device utilizing wind or a rendition device utilizing water.

Moreover, lighting devices such as ceiling area lighting 504, a stand light 505, and a table lamp (not depicted) are disposed as rendition devices utilizing light, in the room where the television receiving device 100 is installed. According to the present embodiment, lighting devices capable of controlling a light volume, a light volume for each wavelength, a light direction, and the like are used as the rendition devices. Note that video image quality control processing such as screen brightness control, color control, resolution conversion, and dynamic range conversion of the display unit 219 may be used as a light rendition effect.

Rendition utilizing light has been conventionally adopted in a stage or the like similarly to rendition utilizing wind. For example, a fear of the user can be incited by rapidly lowering the light volume, and switching to a new scene or the like can be represented by rapidly increasing the light volume. Moreover, a rendition effect further raising a realistic sensation is achievable by using the rendition device utilizing light in combination with rendition devices utilizing other modalities such as the rendition device utilizing wind (described above), and a rendition device utilizing water (e.g., spray 506 described below).

Further, the spray 506 spraying mist or splashes is disposed as a rendition device utilizing water, in the room where the television receiving device 100 is installed. According to the present embodiment, the spray 506 capable of controlling a spray volume, a spray direction, a particle diameter, a temperature, and the like is used as the rendition device. For example, a mystical atmosphere can be rendered by producing fog containing extremely fine particles. A cool atmosphere can also be created by utilizing a cooling effect produced by the heat of vaporization. A creepy and strange atmosphere can be created by producing relatively warm fog. Moreover, the rendition device utilizing water can raise a visual rendition effect of fog when used together with a rendition device utilizing light or a rendition device utilizing wind.

Further, an aroma diffuser (diffuser) 507 which efficiently diffuses a desired scent in a space by utilizing gaseous diffusion or the like is disposed as a rendition device using a scent, in the room where the television receiving device 100 is installed. According to the present embodiment, the aroma diffuser 507 capable of controlling a scent type, concentration, duration, and the like is used as the rendition device. In recent years, effects given from a scent to a body have been gradually demonstrated in a scientific manner through investigations. Moreover, a scent can be classified according to effectiveness. Accordingly, a rendition effect with a stimulus to a sense of smell of the user currently viewing and listening to the content can be obtained by switching the type of the scent diffused from the aroma diffuser 507 or by controlling the concentration of the scent according to scenes of the content being reproduced by the television receiving device 100.

In addition, a smoke generator (not depicted) which ejects smoke in the air is disposed as a rendition device utilizing smoke, in the room where the television receiving device 100 is installed. A typical smoke generator instantly ejects liquified carbon dioxide in the air to generate white smoke. According to the present embodiment, a smoke generator capable of controlling a smoke generation volume, a smoke concentration, a smoke duration, a smoke color, and the like is used as the rendition device. A rendition device utilizing light can be used together with the smoke generator to add a different color to white smoke ejected from the smoke generator. Needless to say, colorful patterns can be added to white smoke by coloring, or colors can be changed from moment to moment. Moreover, a rendition device utilizing wind can be used together with the smoke generator to guide smoke ejected from the smoke generator in a desired direction, or to prevent smoke diffusion toward a particular region. Rendition using smoke has been conventionally adopted in a stage or the like similarly to rendition utilizing wind or light. For example, a high-impact scene can be rendered using powerful white smoke.

Further, a chair 508 installed in front of the screen of the television receiving device 100 as a chair on which the user sit can perform body motion such as a shift action or a vibration action in frontward, rearward, upward, downward, leftward, and rightward directions, and is used as a rendition device utilizing motion. For example, a massage chair may be used as this type of rendition device. In addition, the chair 508 which comes into tight contact with the user sitting thereon can offer a rendition effect by giving the user an electric stimulus to such an extend as not to give health damage or by stimulating a skin sensibility (haptics) or a tactile sense of the user.

Moreover, the chair 508 can have functions of a plurality of other rendition devices utilizing wind, water, a scent, smoke, and the like. When the chair 508 is adopted, the user can directly receive a rendition effect. In this case, power saving is achievable, and it is unnecessary to be concerned about influences on surroundings.

The installation example of the rendition devices depicted in FIG. 5 is presented only by way of example. An autonomous device such as a wearable device, a handy device, an IoT device, an ultrasonic array speaker, and a drone can be used as the rendition device, in addition to the examples depicted in the figure. The wearable device herein includes a device of a bracelet type, a neck strap type, and the like. Moreover, the television receiving device 100 includes the audio output unit 221 constituted by a multichannel speaker or an ultra-multichannel speaker (described above). The audio output unit 221 can be used as a rendition device utilizing sound. For example, by localizing an audio video image such that footsteps of a character included in a video image being displayed on the screen by the display unit 219 approach the user, a rendition effect which feels as if this character walked toward the user can be given. On the contrary, by localizing an audio video image such that footsteps of the character move away from the user, a rendition effect which feels as if this character walked away from the user can be given. Note that band spreading or band degeneracy, and sound quality control processing such as enhancing of a particular band including a low range and a high range may be used as a sound rendition effect.

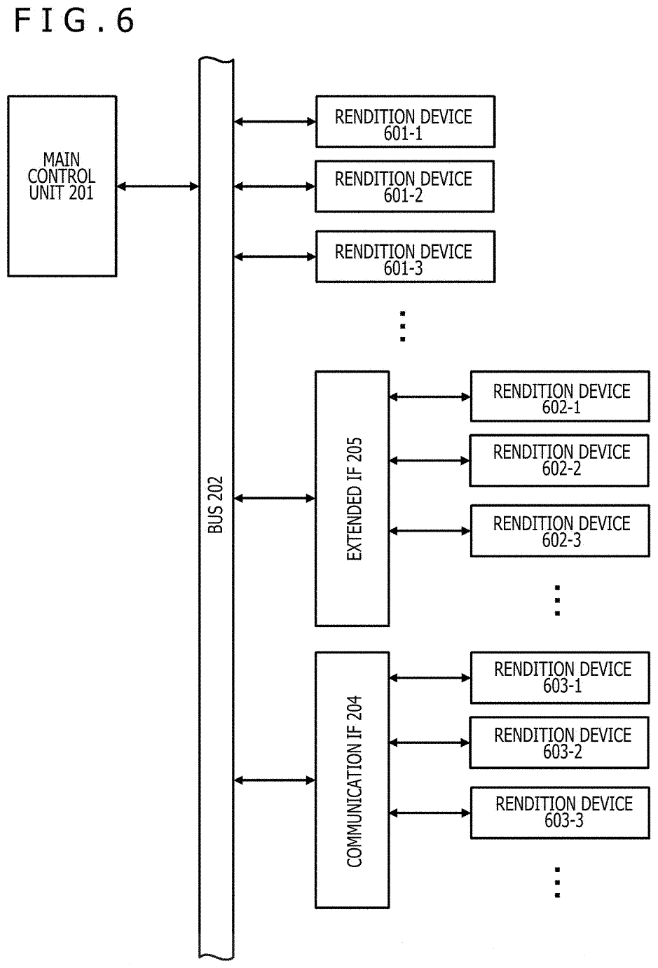

FIG. 6 schematically depicts a control system of the television receiving device 100 for controlling the rendition devices. As described above, many types of rendition devices are applicable to the television receiving device 100.

Each of the rendition devices is classified into either an external device externally connected to the television receiving device 100 or a built-in device provided within the housing of the television receiving device 100.

The former rendition device externally connected to the television receiving device 100 is connected to the television receiving device 100 via the extended interface 205, or via the communication interface 204 with use of a home network. In addition, the rendition device provided as a built-in device is connected to the bus 202. Alternatively, the device which is a built-in rendition device but is a device that has only a general-purpose interface such as a USB and that is not directly connectable to the bus 202, is connected to the television receiving device 100 via the extended interface 205.

According to the example depicted in FIG. 6, there are provided rendition devices 601-1, 601-2, 601-3, and others directly connected to the bus 202, rendition devices 602-1, 602-2, 602-3, and others connected to the bus 202 via the extended interface 205, and rendition devices 603-1, 603-2, 603-3, and others connected using a network via the communication interface 204.

The main control unit 201 transmits, to the bus 202, a command for instructing the respective rendition devices to operate. Each of the rendition devices 601-1, 601-2, 601-3, and others is capable of receiving a command from the main control unit 201 via the bus 202. Moreover, each of the rendition devices 602-1, 602-2, 602-3, and others is capable of receiving a command from the main control unit 201 via the extended interface 205. Further, each of the rendition devices 603-1, 603-2, 603-3, and others is capable of receiving a command from the main control unit 201 via the communication interface 204.

For example, each of the fans 502 and 503 built in the television receiving device 100 is directly connected to the bus 202 or is connected to the bus 202 via the extended interface 205. Moreover, the external devices such as the air conditioner 501, the ceiling area lighting 504, the stand light 505, the table lamp (not depicted), the spray 506, the aroma diffuser 507, and the chair 508 are connected to the bus 202 via the communication interface 204 or via the extended interface 205.

Note that the television receiving device 100 is not necessarily required to include a plurality of types of rendition devices to raise the rendition effect for the content currently viewed and listened to by the user. Even the television receiving device 100 which includes only a single type of rendition device, such as the fans 502 and 503 incorporated in the television receiving device 100, can raise the rendition effect for the content currently viewed and listened to by the user.

### E. Rendition System Using Artificial Intelligence Function

For example, a bodily sensation type rendition technology has been widely used in a movie theater or the like. This technology raises a realistic sensation by stimulating various senses of audience with use of shifting actions of a seat in frontward and rearward, upward and downward, and leftward and rightward directions, wind (cool wind, hot wind), light (e.g., on/off of lighting), water (mist, splash), scents, smoke, and body motion each linked with scenes in a movie currently displayed.

As described above, the television receiving device 100 according to the present embodiment also includes one or a plurality of rendition devices. Accordingly, a bodily sensation type rendition effect is achievable even in a household by using the rendition devices.

In a case of a movie theater, control values of the respective rendition devices are set beforehand. In this manner, an effect of raising a realistic sensation can be obtained by stimulating intervals of audience in synchronization with video images and sound during broadcasting of a movie. For example, concerning a movie broadcasted in a theater handling 4D movies, a creator or the like of the movie sets beforehand control data of a rendition device for stimulating audience in synchronization with video images and sound. Thereafter, the control data is reproduced together with content during broadcasting of the movie. In this manner, a bodily sensation type rendition effect stimulating senses of audience can be raised by driving the rendition device in synchronization with video images and sound.

On the other hand, the television receiving device 100 chiefly installed in an ordinary household and used therein outputs video images or audios of various types of content, such as broadcasting content, streaming content, and reproduction content received from a recording medium. In this case, it is extremely difficult to set beforehand control values of respective rendition devices concerning all of these types of content.

For example, one of methods for achieving bodily sensation type rendition using the television receiving device 100 is to give an instruction indicating a desired stimulus for each scene from the user via the operation input unit 222 or a remote controller while the user is viewing and listening to content. However, it is difficult to give a stimulus to the user according to video images and sound in real time due to a delay produced by an input operation.

Alternatively, another method for achieving bodily sensation type rendition using the television receiving device 100 is to store control data of an instruction given by the user to the respective rendition devices via the operation input unit 222 or the remote controller when the user is viewing and listening to content for the first time, and to reproduce these control data when the user is viewing and listening to the content for the second time or when another user is viewing and listening to the content. In this manner, the rendition devices can be driven in synchronization with video images and sound (e.g., see PTL 6). In this case, however, the user is required to view and listen to the content at least once to set the control data of the rendition devices. This method therefore requires time and labor.

Moreover, skills concerning content creation are variable depending on users. Even if the rendition devices are driven according to control data set by the user himself or herself, a bodily sensation type rendition effect as expected (or at a level equivalent to a professional level) is not necessarily obtained.

In addition, a favorite rendition effect and not favorite (or hated) rendition effect differ for each user. For example, if mist or splashes are applied for each scene to a user who likes a rendition effect utilizing wind but does not like a rendition effect utilizing water, this user does not enjoy content. Moreover, a user may like or dislike (or hate) a stimulus even for the same content, depending on a state of the user such as a physical condition, an environment when the user is viewing and listening to the content, or the like. For example, if a stimulus of hot wind or heat is given on a hot day, the user does not enjoy content.

Accordingly, the technology of the present disclosure estimates a bodily sensation type rendition effect appropriate for each scene with use of an artificial intelligence function while monitoring content such as video images and audios output from the television receiving device 100, and automatically controls driving of respective rendition devices for each scene.

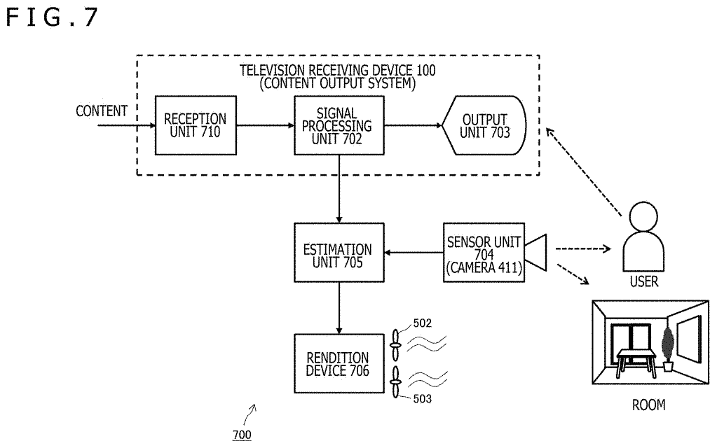

FIG. 7 schematically depicts a configuration example of a rendition system equipped with artificial intelligence function 700 to which the technology of the present disclosure is applied to automatically control driving of the rendition devices provided on the television receiving device 100. The rendition system equipped with artificial intelligence function 700 depicted in the figure includes components within the television receiving device 100 depicted in FIG. 2, or an external device (e.g., a server device on a cloud) outside the television receiving device 100, as necessary.

A reception unit 701 receives video image content. The video image content includes broadcasting content transmitted from a broadcasting station (radio tower or broadcasting satellite) and streaming content distributed from a stream distribution server such as an OTT service. Thereafter, the reception unit 701 separates (demultiplexes) a reception signal into a video image stream and an audio stream, and outputs these streams to a signal processing unit 702 disposed in a following stage. For example, the reception unit 701 is constituted by the tuner/demodulation unit 206, the communication interface unit 204, and the demultiplexer 207 within the television receiving device 100.

The signal processing unit 702 constituted by the video image decoder 2080 and the audio decoder 209 within the television receiving device 100, for example, decodes each of the video image data stream and the audio data stream input from the reception unit 701, and outputs video image data and audio data thus obtained to the output unit 703. Note that the signal processing unit 702 may further perform a video image quality improving process such as a super-resolution process and high dynamic range conversion, or a sound quality improving process such as band spreading (high resolution) for the decoded video images and audios.

The output unit 703 constituted by the display unit 219 and the audio output unit 221 within the television receiving device 100, for example, outputs video image information to the screen to display this information, and outputs audio information from a speaker or the like to provide audios.

A sensor unit 704 is basically constituted by the sensor group 400 depicted in FIG. 4. It is assumed that the sensor unit 704 includes at least the camera 413 which captures an image of a room interior (or installation environment) where the television receiving device 100 is installed. Moreover, it is preferable that the sensor unit 704 includes the environment sensor unit 430 for detecting an environment of the room where the television receiving device 100 is installed.

It is further preferable that the sensor unit 704 includes the camera 411 which captures an image of the user viewing and listening to video image content displayed on the display unit 219, the user state sensor unit 420 which acquires state information associated with a state of the user, and a user profile sensor unit 450 which detects profile information associated with the user.

An estimation unit 705 receives inputs of a video image signal and an audio signal after signal processing (or before signal processing) by the signal processing unit 702, and outputs a control signal for controlling driving of a rendition device 706 such that a bodily sensation type rendition effect suitable for each scene of video images or audios can be obtained. For example, the estimation unit 705 is constituted by the main control unit 201 within the television receiving device 100. According to the present embodiment, it is assumed that the estimation unit 705 performs an estimation process for estimating a control signal for controlling driving of the rendition device 706 with use of a neural network which has learned a correlation between the video images or the audios and the bodily sensation type rendition effect.

Moreover, the estimation unit 705 recognizes the environment of the interior of the room where the television receiving device 100 is installed, and information associated with the user viewing and listening to the television receiving device 100, on the basis of sensor information output from the sensor unit 704 together with the video image signal and the audio signal. Thereafter, the estimation unit 705 outputs a control signal for controlling driving of the rendition device 706 such that a bodily sensation type rendition effect also suitable for a preference of the user, a state of the user, and the room interior environment can be obtained for each scene of the video images or the audios. According to the present embodiment, it is assumed that the estimation unit 705 performs an estimation process for estimating the control signal for controlling driving of the rendition device 706 with use of a neural network which has learned a correlation between the bodily sensation type rendition effect and the video images or the audios as well as a correlation between the bodily sensation type rendition effect and the preference of the user, the state of the user, and the room interior environment.

As described in above Section D with reference to FIG. 5, the rendition device 706 is constituted by at least any one of the respective rendition devices utilizing wind, temperature, light, water (mist, splash), scents, smoke, body motion, and the like. According to the present embodiment, it is assumed that the rendition device 706 includes at least the fans 502 and 503 incorporated in the television receiving device 100 as the rendition device utilizing wind.

The rendition device 706 is driven according to a control signal output from the estimation unit 705 for each scene of content (or in synchronization with video images or audios). For example, in a case where the rendition device 706 is a rendition device utilizing wind, the rendition device 706 controls a wind speed, a wind volume, a wind pressure, a wind direction, fluctuations, an airflow temperature, and the like, according to the control signal output from the estimation unit 705.

As described above, the estimation unit 705 estimates a control signal for controlling driving of the rendition device 706 such that a bodily sensation type rendition effect suitable for each scene of video images or audios can be obtained. Moreover, the estimation unit 705 estimates a control signal for controlling driving of the rendition device 706 such that a bodily sensation type rendition effect also suitable for a preference of the user, a state of the user, and a room interior environment can be obtained for each scene of video images or audios. Accordingly, by driving the rendition device 706 according to the control signal output from the estimation unit 705, a bodily sensation type rendition effect synchronized with video images or audios is achievable at the time at which signal processing of content received by the reception unit 701 is performed by the signal processing unit 702 and the processed content is output from the output unit 703.

The reception unit 701 receives various types of content such as broadcasting content, streaming content, and recording medium reproducing content, and outputs the received content from the output unit 703. According to the rendition system equipped with artificial intelligence function 700, a bodily sensation type rendition effect synchronized with video images or audios is achievable in real time for any type of the content.

The present embodiment is chiefly characterized in that the estimation process performed by the estimation unit 705 for estimating a bodily sensation type rendition effect is achieved using a neural network which has learned a correlation between the bodily sensation type rendition effect and video images or audios, or a neural network which has learned a correlation between the bodily sensation type rendition effect and video images or audios as well as a correlation between the bodily sensation type rendition effect and a preference of the user, a state of the user, and a room interior environment.

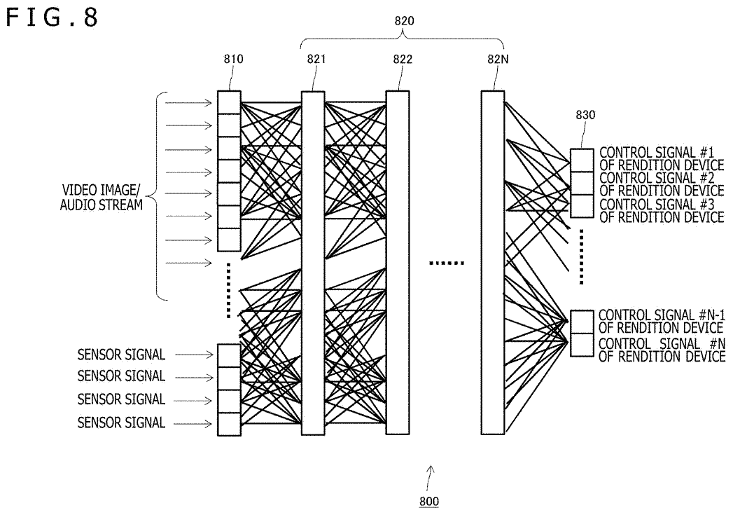

FIG. 8 depicts a configuration example of a bodily sensation type rendition effect estimation neural network 800 which has learned a correlation between a bodily sensation type rendition effect and video images or audios as well as a correlation between the bodily sensation type rendition effect and a preference of the user, a state of the user, and a room interior environment. The bodily sensation type rendition effect estimation neural network 800 is constituted by an input layer 810 which receives inputs of video image signals, audio signals, and sensor signals, an intermediate layer 820, and an output layer 830 which outputs control signals to the rendition device 760. According to the example depicted in the figure, the intermediate layer 820 is constituted by a plurality of intermediate layers 821, 822, and others to allow the content derivation neural network 800 to perform DL. Note that the intermediate layer 820 may have a recurrent neural network (RNN) structure including recurrent joins, in consideration of processing of time-series information such as video image signals and audio signals.

The input layer 810 includes one or more input nodes each receiving video image signals and audio signals after signal processing (or before signal processing) performed by the signal processing unit 702, and one or more sensor signals included in the sensor group 400 depicted in FIG. 4.

The output layer 830 includes a plurality of output nodes corresponding to respective control signals given to the rendition device 706. In addition, the output layer 830 recognizes a scene of content on the basis of the video image signals and the audio signals input to the input layer 810, estimates a bodily sensation type rendition effect suitable for the scene, or a bodily sensation type rendition effect also suitable for the scene, a state of the user, and a room interior environment, and fires the output nodes corresponding to the control signals given to the rendition device 706 for achieving the estimated rendition effect.

The rendition device 706 is driven according to the control signals output from the bodily sensation type rendition effect estimation neural network 800 functioning as the estimation unit 705, to perform a bodily sensation type rendition effect. For example, in a case where the rendition device 706 is constituted by the fans 502 and 503 incorporated in the television receiving device 100, the rendition device 706 controls a wind speed, a wind volume, a wind pressure, a wind direction, fluctuations, an airflow temperature, and the like, according to the control signals.

In a learning process of the bodily sensation type rendition effect estimation neural network 800, an enormous volume of combinations, which are constituted by a video image or an audio output from the television receiving device and a bodily sensation type rendition effect performed in an environment where the television receiving device 100 is installed, are input to the bodily sensation type rendition effect estimation neural network 800. Thereafter, weighting factors of the respective nodes of the intermediate layer 820 are updated such that intensity of junction with the probable bodily sensation type rendition effect increases for the video image or the audio. In this manner, a correlation between the video image or the audio and the bodily sensation type rendition effect is learned. For example, teacher data constituted by a correlation between the video image or the audio and the bodily sensation type rendition effect, such as a blast as produced by an air cannon for a loud explosion and a breeze floating with ripples for a quiet lakeside, is input to the bodily sensation type rendition effect estimation neural network 800. Thereafter, the bodily sensation type rendition effect estimation neural network 800 sequentially discovers a control signal given to the rendition device 706 for achieving a bodily sensation type rendition effect suitable for the video image or the audio.

In addition, in an identification process performed by the bodily sensation type rendition effect estimation neural network 800 (execution of a bodily sensation type rendition), the bodily sensation type rendition effect estimation neural network 800 outputs, with high reliability, control signals given to the rendition device 706 for achieving a bodily sensation type rendition effect to be appropriately applied to video images or audios input (or output from the television receiving device 100). The rendition device 706 is driven according to the control signals output from the output layer 830, to achieve a bodily sensation type rendition effect appropriate for video images or audios (i.e., scenes of content) and to thereby raise a realistic sensation of the user.

The bodily sensation type rendition effect estimation neural network 800 depicted in FIG. 8 is implemented within the main control unit 201, for example. Accordingly, a processor dedicated for the neural network may be included in the main control unit 201. Alternatively, the bodily sensation type rendition effect estimation neural network 800 may be provided on a cloud on the Internet. However, it is preferable to provide the bodily sensation type rendition effect estimation neural network 800 within the television receiving device 100 to produce a bodily sensation type rendition effect in real time for each scene of content output from the television receiving device 100.

For example, the television receiving device 100 which incorporates the bodily sensation type rendition effect estimation neural network 800 having completed learning using an expert teaching database is shipped. The bodily sensation type rendition effect estimation neural network 800 may continuously perform learning using an algorithm such as back propagation. Alternatively, the bodily sensation type rendition effect estimation neural network 800 within the television receiving device 100 installed in each household may be updated using learning results obtained on the basis of data collected from an enormous number of users on the cloud side on the Internet. This point will be described below.

### F. Update and Customization of Neural Network

Described above has been the bodily sensation type rendition effect estimation neural network 800 used in the process of giving a bodily sensation type rendition effect to video images or audios output from the television receiving device 100.

The bodily sensation type rendition effect estimation neural network 800 operates in a device constituting the television receiving device 100 installed in each household and directly operated by the user, or in an operation environment of a household or the like where this device is installed (hereinafter referred to as a “local environment”). One of advantageous effects produced by the point that the bodily sensation type rendition effect estimation neural network 800 operates, as an artificial intelligence function, in the local environment is that learning by the respective neural networks is easily achievable in real time on the basis of feedback or the like from the user as teacher data with use of an algorithm such as back propagation, for example. In other words, the bodily sensation type rendition effect estimation neural network 800 can be customized or personalized for a particular user through direct learning using feedback received from the user.

The feedback from the user is an evaluation given from the user when a bodily sensation type rendition effect is performed using the bodily sensation type rendition effect estimation neural network 800 for video images or audios output from the television receiving device 100. The feedback from the user may be simple feedback (or two-value feedback) indicating OK (good) or NG (not good) for the bodily sensation type rendition effect, or may be a multilevel evaluation. Alternatively, an evaluation comment made by the user concerning the bodily sensation type rendition effect output from the rendition device 706 may be given by audio input, and may be handled as the feedback of the user. For example, the user feedback is input to the television receiving device 100 via the operation input unit 222, a remote controller, a voice agent as one mode of artificial intelligence, a linked smartphone, or the like. Moreover, a mental state or a physiological state of the user detected by the user state sensor unit 420 when the rendition device 706 outputs a bodily sensation type rendition effect may be handled as the feedback of the user.

On the other hand, another possible method is to collect data from an enormous number of users, in one or more server devices operating in a cloud corresponding to an aggregation of server devices (hereinafter also simply referred to as a “cloud”) on the Internet, to accumulate learning by a neural network as an artificial intelligence function, and to update the bodily sensation type rendition effect estimation neural network 800 within the television receiving device 100 in each household by using a learning result obtained by the learning. One of advantageous effects produced by the update of the neural network performing the function of artificial intelligence in the cloud is that construction of more reliable neural network is achievable by learning on the basis of a large volume of data.

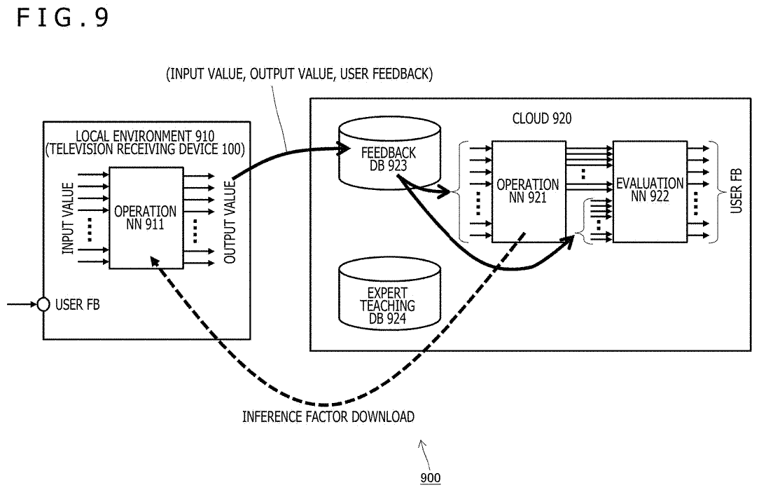

FIG. 9 schematically depicts a configuration example of an artificial intelligence system 900 using a cloud. The artificial intelligence system 900 using a cloud depicted in the figure is constituted by a local environment 910 and a cloud 920.

The local environment 910 corresponds to an operation environment (household) where the television receiving device 100 is installed, or the television receiving device 100 installed in a household. While FIG. 9 only depicts the one local environment 910 for simplification, it is assumed in reality that an enormous number of local environments are connected to the one cloud 920. Moreover, while the operation environment such as a household where the television receiving device 100 operates is chiefly presented as an example of the local environment 910 in the present embodiment, the local environment 910 may be an environment where any device equipped with a screen for displaying content, such as a smartphone, a tablet, and a personal computer, operates (including public facilities such as a station, a bus stop, an airport, and a shopping center, and labor facilities such as a plant and a workplace).

As described above, the bodily sensation type rendition effect estimation neural network 800 for giving a bodily sensation type rendition effect in synchronization with video images or audios is provided as an artificial intelligence within the television receiving device 100. These types of neural networks provided within the television receiving device 100 and actually used will be herein collectively referred to as an operation neural network 911. It is assumed that the operation neural network 911 has already learned a correlation between video images or audios output from the television receiving device 100 and a bodily sensation type rendition effect synchronized with the video images or the audios, by using an expert teaching database constituted by an enormous volume of sample data.

On the other hand, the cloud 920 includes the artificial intelligence server (described above) (constituted by one or more server devices) for providing an artificial intelligence function. The artificial intelligence server is a server in which an operation neural network 921 and an evaluation neural network 922 for evaluating the operation neural network 921 are disposed. It is assumed that the operation neural network 921 has the same configuration as the configuration of the operation neural network 911 disposed in the local environment 910 and has already learned a correlation between video images or audios and a bodily sensation type rendition effect synchronized with the video images or the audios, by using an expert teaching database 924 constituted by an enormous volume of sample data. Moreover, the evaluation neural network 922 is a neural network used for evaluating a leaning status of the operation neural network 921.

The operation neural network 911 on the local environment 910 side receives inputs of video image signals and audio signals currently output from the television receiving device 100 as well as an input, from the sensor unit 400, of sensor information associated with an installation environment of the television receiving device 100 and with a user state or a user profile, and outputs control signals to the rendition device 706 to obtain a bodily sensation type rendition effect synchronized with the video images or audios (in a case where the operation neural network 911 is the bodily sensation type rendition effect estimation neural network 800). The inputs to the operation neural network 911 will be herein simply referred to as “input values,” and outputs from the operation neural network 911 will be simply referred to as “output values” for simplification.

A user of the local environment 910 (e.g., audience of the television receiving device 100) evaluates the output values from the operation neural network 911, and feeds back an evaluation result to the television receiving device 100 with use of the operation input unit 222, a remote controller, a voice agent, a linked smartphone, or the like, for example. It is assumed herein that the user feedback is either OK (0) or NG (1) for simplifying explanation. Specifically, the user expresses whether or not he or she likes a bodily sensation type rendition effect output from the rendition device 706 in synchronization with video images or audios of the television receiving device 100 by using two values of OK (0) and NG (1).

Feedback data constituted by a combination of user feedback, and an input value and an output value of the operation neural network 911 is transmitted from the local environment 910 to the cloud 920. Feedback data transmitted from an enormous number of local environments is accumulated in a feedback database 923 within the cloud 920. An enormous volume of feedback data describing a correspondence between the user and the input value and the output value of the operation neural network 911 is accumulated in the feedback database 923.

Moreover, the cloud 920 is allowed to retain or use the expert teaching database 924 constituted by an enormous volume of sample data and used for pre-learning by the operation neural network 911. Each sample data is teacher data describing a correspondence among video images or audios, sensor information, and the output value (control signals to the rendition device 706) of the operation neural network 911 (or 921).

After feedback data is extracted from the feedback database 923, input values included in the feedback data (e.g., video images or audios and sensor information) are input to the operation neural network 921. Moreover, output values from the operation neural network 921 (control signals to the rendition device 706) and input values included in corresponding feedback data (e.g., video images or audios and sensor information) are input to the evaluation neural network 922. Thereafter, the evaluation neural network 922 outputs estimation values of the user feedback.

Learning by the evaluation neural network 922 as a first step and learning by the operation neural network 921 as a second step are alternately performed in the cloud 920.

The evaluation neural network 922 is a network which learns a correspondence between an input value to the operation neural network 921 and user feedback for an output from the operation neural network 921. Accordingly, in the first step, the evaluation neural network 922 receives an input of an output value from the operation neural network 921, and user feedback included in corresponding feedback data. Thereafter, the evaluation neural network 922 defines a loss function based on a difference between user feedback output from the evaluation neural network 922 itself for the output value from the operation neural network 921 and actual user feedback for the output value from the operation neural network 921, and learns such that the loss function becomes the minimum. As a result, the evaluation neural network 922 learns in such a manner as to output, for the outputs from the operation neural network 921, user feedback (OK or NG) similar to actual user feedback.

In the subsequent second step, learning by the operation neural network 921 is performed next while maintaining the evaluation neural network 922. As described above, after extraction of feedback data from the feedback database 923, input values included in the feedback data are input to the operation neural network 921, while output values from the operation neural network 921 and data of user feedback included in the corresponding feedback data are input to the evaluation neural network 922. Thereafter, the evaluation neural network 922 outputs user feedback equivalent to actual user feedback.

At this time, the operation neural network 921 applies a loss function to an output from an output layer of the operation neural network 921 itself, and perform learning using back propagation such that a value thus obtained becomes the minimum. For example, in a case where user feedback is used as teacher data, the operation neural network 921 inputs output values from the operation neural network 921 (control signals given to the rendition device 706) for an enormous volume of input values (video images or audios and sensor information) to the evaluation neural network 922, and learns such that all user evaluations estimated by the evaluation neural network 922 become OK (0). The operation neural network 921 performing such learning is capable of outputting, for any input value (sensor information), an output value receiving feedback of OK from the user (a control signal for the rendition device 706 for giving the user a stimulus raising the bodily sensation rendition effect in synchronization with a video image or an audio).

Moreover, the expert teaching database 924 may be used as teacher data during learning by the operation neural network 921. Further, learning may be performed using two or more types of teacher data such as user feedback and the expert teaching database 924. In this case, learning by the operation neural network 921 may be carried out such that a sum of loss functions calculated and weighted for each teacher data becomes the minimum.

Reliability output from the operation neural network 921 improves by alternately performing the above-described learning by the evaluation neural network 922 as the first step and the above-described learning by the operation neural network 921 as the second step. Thereafter, an inference factor of the operation neural network 921 having higher reliability due to the learning is provided for the operation neural network 911 in the local environment 910. In this manner, the user is also allowed to obtain benefits of the operation neural network 911 having learned more. As a result, an occasion for giving the user a stimulus raising the bodily sensation type rendition effect of the rendition device 706 in synchronization with video images or audios output from the television receiving device 100 increases.

The inference factor whose reliability has been improved in the cloud 920 may be provided for the local environment 910 by any method. For example, a bit stream of an inference factor of the operation neural network 921 may be compressed and downloaded from the cloud 920 to the television receiving device 100 in the local environment 910. When the bit stream has a large size even after compression, the inference factor may be divided into parts separated for each layer or region, and the compressed bit stream may be downloaded plural times for the parts.

### INDUSTRIAL APPLICABILITY

The technology according to the present disclosure has been described above in detail with reference to the specific embodiment. However, it is obvious that those skilled in the art can make corrections or substitutions for the embodiment without departing from the subject matters of the technology of the present disclosure.

While the embodiment which applies the technology of the present disclosure to the television receiver has been chiefly described in the present specification, the subject matters of the technology according to the present disclosure are not limited to this example. The technology according to the present disclosure is also applicable to a content acquisition device, a content reproduction device, or a display device which each include a display having various types of content acquisition and reproduction functions for acquiring various types of reproduction content such as video images and audios with use of broadcasting waves or by streaming or downloading via the Internet, and presenting the acquired reproduction content to a user.

In short, the technology according to the present disclosure has been described by way of example, and it is therefore not intended that the contents described in the present specification be interpreted as limiting contents. The claims should be taken into consideration so as to determine the subject matters of the technology according to the present disclosure.

Note that the technology according to the present disclosure can also have following configurations.

(1)

An information processing apparatus that controls an operation of an external device of a display with use of an artificial intelligence function, the information processing apparatus including:

an acquisition unit that acquires a video image or an audio output from the display;

an estimation unit that estimates the operation of the external device synchronized with the video image or the audio with use of the artificial intelligence function; and an output unit that outputs an instruction of the estimated operation to the external device.

(2)

The information processing apparatus according to claim 1, in which the estimation unit estimates the operation of the external device synchronized with the video image or the audio with use of a neural network having learned a correlation between the video image or the audio output from the display and the operation of the external device.

(3)

The information processing apparatus according to claim 1 or 2, in which the external device includes a rendition device that outputs a rendition effect on the basis of the estimated operation.

(4)

The information processing apparatus according to claim 3, in which the rendition device includes a rendition device utilizing wind.

(5)

The information processing apparatus according to claim 4, in which the rendition device further includes a rendition device that utilizes at least one of temperature, water, light, a scent, smoke, and body motion.

(6)

An information processing method that controls an operation of an external device of a display with use of an artificial intelligence function, the information processing method including:

an acquisition step that acquires a video image or an audio output from the display;

an estimation step that estimates the operation of the external device synchronized with the video image or the audio with use of the artificial intelligence function; and an output step that outputs an instruction of the estimated operation to the external device.

(7)

A display equipped with artificial intelligence function, the display including:

a display unit;

an estimation unit that estimates, with use of an artificial intelligence function, an operation of an external device synchronized with a video image or an audio output from the display unit; and an output unit that outputs an instruction of the estimated operation to the external device.

(7-1)

The display equipped with artificial intelligence function according to (7) described above, in which the estimation unit estimates the operation of the external device synchronized with the video image or the audio with use of a neural network having learned a correlation between the video image or the audio output from the display and the operation of the external device.

(7-2)

The display equipped with artificial intelligence function according to (7) or (7-1) described above, in which the external device is a rendition device that outputs a rendition effect on the basis of the estimated operation.

(7-3)

The display equipped with artificial intelligence function according to (7-2) described above, in which the rendition device includes a rendition device utilizing wind.

(7-4)

The display equipped with artificial intelligence function according to (7-3) described above, in which the rendition device further includes a rendition device that utilizes at least one of temperature, water, light, a scent, smoke, and body motion.

(8)

A rendition system equipped with artificial intelligence function, the rendition system including:

a display unit;

an external device; and

an estimation unit that estimates an operation of the external device synchronized with a video image or an audio with use of an artificial intelligence function.

(8-1)

The rendition system equipped with artificial intelligence function according to (8) described above, in which the estimation unit estimates the operation of the external device synchronized with the video image or the audio with use of a neural network having learned a correlation between the video image or the audio output from the display and the operation of the external device.

(8-2)

The rendition system equipped with artificial intelligence function according to (8) or (8-1) described above, in which the external device is a rendition device that outputs a rendition effect on the basis of the estimated operation.

(8-3)

The rendition system equipped with artificial intelligence function according to (8-2) described above, in which the rendition device includes a rendition device utilizing wind.

(8-4)

The rendition system equipped with artificial intelligence function according to (8-3) described above, in which the rendition device further includes a rendition device that utilizes at least one of temperature, water, light, a scent, smoke, and body motion.

### REFERENCE SIGNS LIST

100: Television receiving device
201: Main control unit
202: Bus
203: Storage unit
204: Communication interface (IF) unit
205: Extended interface (IF) unit
206: Tuner/demodulation unit
207: Demultiplexer
208: Video image decoder
209: Audio decoder
210: Superimpose decoder
211: Subtitle decoder
212: Subtitle synthesis unit
213: Data decoder
214: Cache unit
215: Application (AP) control unit
216: Browser unit
217: Sound source unit
218: Video image synthesis unit
219: Display unit
220: Audio synthesis unit
221: Audio output unit
222: Operation input unit
400: Sensor group
410: Camera unit
411 to 413: Camera
420: User state sensor unit
430: Environment sensor unit
440: Device state sensor unit
450: User profile sensor unit
501: Air conditioner
502, 503: Fan
504: Ceiling area lighting
505: Stand light
506: Spray
507: Aroma diffuser
508: Chair
700: Rendition system equipped with artificial intelligence function rendition system
701: Reception unit
702: Signal processing unit
703: Output unit
704: Sensor unit
705: Estimation unit
706: Rendition device
800: Bodily sensation type rendition effect estimation neural network
810: Input layer
820: Intermediate layer
8630: Output layer
910: Local environment
911: Operation neural network
920: Cloud
921: Operation neural network
922: Evaluation neural network
923: Feedback database
924: Expert teaching database

1. An information processing apparatus that controls an operation of an external device of a display with use of an artificial intelligence function, the information processing apparatus comprising:
an acquisition unit that acquires a video image or an audio output from the display;
an estimation unit that estimates the operation of the external device synchronized with the video image or the audio with use of the artificial intelligence function; and
an output unit that outputs an instruction of the estimated operation to the external device.

2. The information processing apparatus according to claim 1, wherein the estimation unit estimates the operation of the external device synchronized with the video image or the audio with use of a neural network having learned a correlation between the video image or the audio output from the display and the operation of the external device.

3. The information processing apparatus according to claim 1, wherein the external device includes a rendition device that outputs a rendition effect on a basis of the estimated operation.

4. The information processing apparatus according to claim 3, wherein the rendition device includes a rendition device utilizing wind.

5. The information processing apparatus according to claim 4, wherein the rendition device further includes a rendition device that utilizes at least one of temperature, water, light, a scent, smoke, and body motion.

6. An information processing method that controls an operation of an external device of a display with use of an artificial intelligence function, the information processing method comprising:
an acquisition step that acquires a video image or an audio output from the display;
an estimation step that estimates the operation of the external device synchronized with the video image or the audio with use of the artificial intelligence function; and
an output step that outputs an instruction of the estimated operation to the external device.

7. A display equipped with artificial intelligence function, the display comprising:
a display unit;
an estimation unit that estimates, with use of an artificial intelligence function, an operation of an external device synchronized with a video image or an audio output from the display unit; and
an output unit that outputs an instruction of the estimated operation to the external device.

8. A rendition system equipped with artificial intelligence function, the rendition system comprising:
a display unit;
an external device; and
an estimation unit that estimates an operation of the external device synchronized with a video image or an audio with use of an artificial intelligence function.
